(19) United States
(12) Patent Application Publication
(10) Pub. No.: US 2026/0212676 A1
(43) Pub. Date: Jul. 23, 2026

(54) INFORMATION PROCESSING APPARATUS, INFORMATION PROCESSING SYSTEM, INFORMATION PROCESSING METHOD, AND NON-TRANSITORY COMPUTER READABLE MEDIUM

(71) Applicant: NEC CORPORATION, Tokyo (JP)

(72) Inventors: Takumi OZAKI, Tokyo (JP); Jianquan LIU, Tokyo (JP); Tingting DONG, Tokyo (JP); Noboru YOSHIDA, Tokyo (JP); Takayuki KASE, Tokyo (JP)

(73) Assignee: NEC Corporation, Tokyo (JP)

(21) Appl. No.: 19/141,551

(22) PCT Filed: Dec. 6, 2023
(86) PCT No.: PCT/JP2023/043596

§ 371 Date: Jun. 20, 2025

(30) Foreign Application Priority Data
Dec. 28, 2022 (JP) 2022-211664

(51) Int. Cl. G06V 20/52; G06T 7/20; G06T 7/70; G06V 20/40

(52) U.S. Cl. CPC G06V 20/52; G06T 7/20; G06T 7/70; G06V 20/44; G06T 2207/30196

(57) ABSTRACT

An information processing apparatus includes an object acquisition unit and a risk degree acquisition unit. The object acquisition unit acquires object information relating to an object captured in a video, by using analysis information acquired by analyzing the video capturing an object region. The risk degree acquisition unit determines a degree of risk of the object by using the object information. The object information includes a position and an attribute of an accommodating tool.

### TECHNICAL FIELD

The present invention relates to an information processing apparatus, an information processing system, information processing method, and a medium.

### BACKGROUND ART

For example, Patent Document 1 discloses a technique for determining degree of suspiciousness of a visitor. In Patent Document 1, an example in which the degree of suspiciousness is determined on three levels, which are 0, 0.5, and 1, based on whether a police officer is nearby human and whether the visitor puts his or her hand into a bag, is disclosed. In the technique described in Patent Document 1, in a case where a visitor puts his or her hand into a bag, it may be a movement to take out a weapon or a dangerous object, and thus 1 is output in a case where the visitor puts his or her hand into the bag at a time when a police officer is nearby. In even a case where no police officer is nearby, this movement still requires caution, and thus 0.5 is output. In a case where the visitor does not put his or her hand into the bag, 0 is output.

Patent Document 1 describes that “in a case where a position of a hand skeleton of a person and a position of a bag do not overlap, it is determined to be a state in which a hand is not put in the bag, and in a case where a position of the hand skeleton of the person and a position of the bag overlap, is determined to be a state in which the hand is put in the bag. When a state changes from the state in which the hand is not put in the bag, which is movement information, to the state in which the hand is put in the bag, it is determined that the person puts his or her hand in the bag.”

Note that, Patent Document 2 describes a technique of computing a feature value of each of a plurality of key points of a human body included in an image, searching, based on the computed feature value, for an image including a human body of which pose is similar or a human body of which movement is similar, and classifying the images by grouping images that include similar pose or movement together.

### RELATED DOCUMENT

### Patent Document

Patent Document 1: Japanese Patent Application Publication No. 2021-135646

Patent Document 2: International Patent Publication No. WO 2021/084677

### SUMMARY

### Technical Problem

In the technique described in Patent Document 1, as described above, whether a hand of a person is put in a bag is determined based on whether a position of a hand skeleton of a person and a position of the bag overlap. However, for example, in a case where a lid of the bag is closed, even when a position of the hand skeleton of the person and a position of the bag overlap, it is unlikely to be a movement to take out a weapon or a dangerous object. Thus, it is difficult to detect a degree of risk in an object region with high accuracy by using the technique described in Patent Document 1.

Note that, Patent Document 2 does not disclose a technique for detecting a degree of risk in an object region.

In view of the above-described problem, one example of an object of the present invention is to provide an information processing apparatus, an information processing system, an information processing method, a program, a medium, and the like that solve detection of a degree of risk in an object region with high accuracy.

### Solution to Problem

According to one aspect of the present invention,
an information processing apparatus including:
an object acquisition unit that acquires object information relating to an object captured in a video, by using analysis information acquired by analyzing the video capturing an object region; and
a risk degree acquisition unit that determines a degree of risk of the object by using the object information, wherein
the object information includes a position and a state of an accommodating tool is provided.

According to one aspect of the present invention,
an information processing system including:
the above-described information processing apparatus;
at least one capturing apparatus that generates a video by capturing the object region; and
an analysis apparatus that generates the analysis information by analyzing a video generated by the at least one capturing unit is provided.

According to one aspect of the present invention,
an information processing method including,
by one or more computers:
acquiring object information relating to an object captured in a video, by using analysis information acquired by analyzing the video capturing an object region; and
determining a degree of risk of the object by using the object information, wherein
the object information includes a position and a state of an accommodating tool is provided.

According to one aspect of the present invention,
a medium recording a program for causing one or more computers to execute:
acquisition of object information relating to an object captured in a video, by using analysis information acquired by analyzing the video capturing an object region; and
determination of a degree of risk of the object by using the object information, wherein
the object information includes a position and a state of an accommodating tool is provided.

### Advantageous Effects of Invention

According to one aspect of the present invention, it is possible to detect a degree of risk in an object region with high accuracy.

### BRIEF DESCRIPTION OF THE DRAWINGS

FIG. 1 is a diagram illustrating an outline of an information processing apparatus according to an example embodiment 1.

FIG. 2 is a diagram illustrating an outline of an information processing system according to the example embodiment 1.

FIG. 3 is a flowchart illustrating an outline of information processing according to the example embodiment 1.

FIG. 4 is a diagram illustrating a configuration example of the information processing system according to the example embodiment 1.

FIG. 5 is a diagram illustrating a functional configuration example of the information processing apparatus according to the example embodiment 1.

FIG. 6 is a diagram illustrating a physical configuration example of the information processing apparatus according to the example embodiment 1.

FIG. 7 is a flowchart illustrating an example of risk detection processing according to the example embodiment 1.

FIG. 8 is a diagram illustrating one example of a risk degree determination criterion according to the example embodiment 1.

FIG. 9 is a diagram illustrating a functional configuration example of an information processing apparatus according to an example embodiment 2.

FIG. 10 is a flowchart illustrating an example of risk detection processing according to the example embodiment 2.

FIG. 11 is a diagram illustrating one example of a risk degree determination criterion according to the example embodiment 2.

FIG. 12 is diagram illustrating a configuration example of an information processing system according to an example embodiment 3.

FIG. 13 is a diagram illustrating a functional configuration example of an information processing apparatus according to the example embodiment 3.

FIG. 14 is a flowchart illustrating an example of risk detection processing according to the example embodiment 3.

FIG. 15 is a diagram illustrating a functional configuration example of an information processing apparatus according to an example embodiment 4.

FIG. 16 is a flowchart illustrating an example of risk detection processing according to the example embodiment 4.

FIG. 17 is a diagram illustrating one example of a risk degree determination criterion according to the example embodiment 4.

### EXAMPLE EMBODIMENT

In the following, example embodiments of the present invention are described with reference to the drawings. Note that, in all the drawings, a similar component is denoted with a similar reference sign, and description thereof is omitted as appropriate.

### Example Embodiment 1

### (Outline)

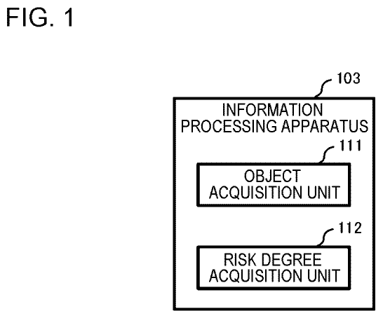

FIG. 1 is a diagram illustrating an outline of an information processing apparatus 103 according to an example embodiment 1. The information processing apparatus 103 includes an object acquisition unit 111, and a risk degree acquisition unit 112.

The object acquisition unit 111 acquires object information relating to an object captured in a video, by using analysis information acquired by analyzing the video capturing an object region. The risk degree acquisition unit 112 determines a degree of risk of the object by using the object information. The object information includes a position and a state of an accommodating tool.

According to the information processing apparatus 103, it is possible to detect a degree of risk in the object region with high accuracy.

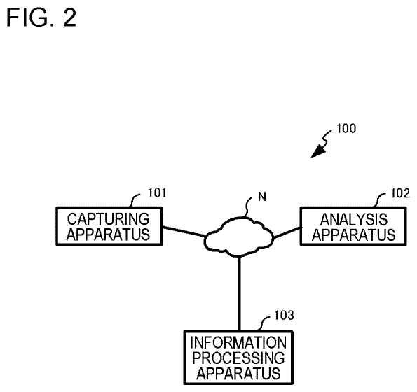

FIG. 2 is a diagram illustrating an outline of an information processing system 100 according to the example embodiment 1. The information processing system 100 includes the information processing apparatus 103, at least one capturing apparatus 101, and an analysis apparatus 102. The capturing apparatus 101 generates a video by capturing an object region. The analysis apparatus 102 generates analysis information by analyzing the video generated by the at least one capturing apparatus 101.

According to the information processing system 100, it is possible to detect a degree of risk in the object region with high accuracy.

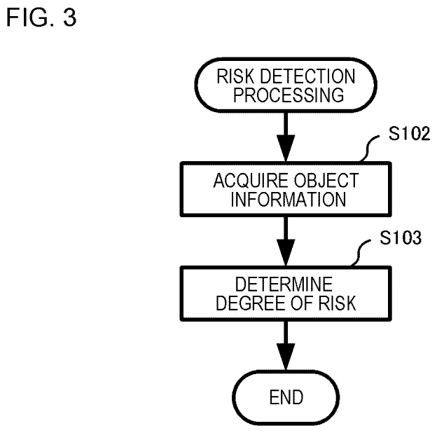

FIG. 3 is a flowchart illustrating an outline of information processing according to the example embodiment 1.

The object acquisition unit 111 acquires object information relating to an object captured in a video, by using analysis information acquired by analyzing the video capturing an object region (step S102).

The risk degree acquisition unit 112 determines a degree of risk of the object by using the object information (step S103).

The object information includes a position and a state of an accommodating tool.

According to such information processing, it is possible to detect a degree of risk in the object region with high accuracy.

In the following, a detailed example of the information processing system 100 according to the example embodiment 1 is described.

### (Details)

### (Configuration Example of Information Processing System 100 According to Example Embodiment 1)

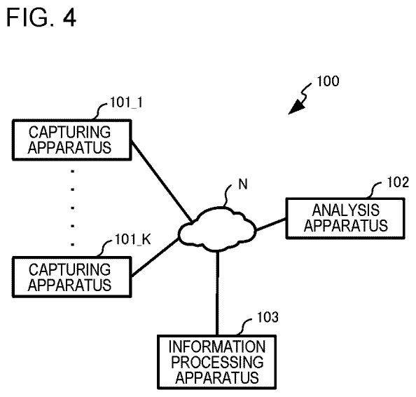

FIG. 4 is a diagram illustrating a configuration example of the information processing system 100 according to the example embodiment 1. The information processing system 100 is a system for detecting a degree of risk in an object region with high accuracy. The object region is any region to be surveilled. The information processing system 100 includes at least one of capturing apparatuses 101_1 to 101_K, the analysis apparatus 102, and the information processing apparatus 103.

K is an integer equal to or greater than one. In a case where the capturing apparatuses 101_1 to 101_K are not particularly distinguished from each other, the capturing apparatuses 101_1 to 101 K are also referred to as the “capturing apparatus 101”.

The at least one of capturing apparatuses 101_1 to 101_K, the analysis apparatus 102, and the information processing apparatus 103 are connected to each other via a network N configured as wired, wireless, or a combination thereof, and mutually transmit and receive information via the network N.

Each of the at least one capturing apparatus 101 is an apparatus that generates a video by capturing the object region.

### (Functional Configuration Example of Analysis Apparatus 102 According to Example Embodiment 1)

The analysis apparatus 102 acquires a video generated by each of the at least one capturing apparatus 101, for example, via the network N. Note that, a method in which the analysis apparatus 102 acquires a video is not limited thereto.

The analysis apparatus 102 generates analysis information by analyzing a video acquired from the at least one capturing apparatus 101. The analysis information includes, for example, an image feature value of a physical object captured in the video, and the like. Note that, the analysis information may be information including one or more types of information generated in analysis processing described in the following.

Herein, the “physical object” includes both an item and a person. Note that, the physical object may be only an item.

In detail, the analysis apparatus 102 includes one or a plurality of analysis functions that perform processing (analysis processing) for analyzing a video. The analysis function that the analysis apparatus 102 includes is one or a plurality of (1) a physical object detection function, (2) a face analysis function, (3) a human figure analysis function, (4) a pose analysis function, (5) an action analysis function, (6) an appearance attribute analysis function, (7) a gradient feature analysis function, (8) a color feature analysis function, (9) a traffic line analysis function, and the like. Note that, the analysis function that the analysis apparatus 102 includes is not limited to these functions.
(1) The physical object detection function detects a physical object from an image. The physical object detection function can also determine a position of the physical object in the image. A model applied to physical object detection processing includes, for example, you only look once (YOLO).
(2) The face analysis function detects a face of a person from an image, and performs extraction of a feature value (face feature value) of the detected face, classification (division by class) of the detected face, and the like. The face analysis function can also determine a position of the face in the image. The face analysis function can also determine identity of persons detected from different images, based on a similarity and the like of face feature values of the persons detected from the different images.
(3) The human figure analysis function performs extraction of a human body related feature value (for example, a value indicating an overall feature, such as a body shape such as a skinny figure or a fuller figure, a body height, clothing, and the like) of a person included in an image, classification (division by class) of the person included in the image, and the like. The human figure analysis function can also determine a position of the person in the image. The human figure analysis function can also determine identity of persons included in different images, based on human body related feature values and the like of the persons included in the different images.
(4) The pose analysis function detects a joint point of a person from an image, and generates a stick human model acquired by connecting the joint points. Then, the pose analysis function estimates a pose of the person by using information of the stick human model, and performs extraction of a feature value (pose feature value) of the estimated pose, classification (division by class) of the person included in the image, and the like. The pose analysis function can also determine identity of persons included in different images, based on pose feature values and the like of the persons included in the different images.

For example, the pose analysis function estimates, from an image, a pose such as a standing pose, a squatting pose, a slouching pose, and the like, and extracts a pose feature value indicating each pose. Further, for example, the pose analysis function can estimate, from an image, a pose of an item detected by using the physical object detection function and the like, and extract a pose feature value indicating the pose.

The pose analysis function can be applied with, for example, the technique disclosed in Patent Document 2.
(5) The action analysis processing can estimate a movement of a person by using information of a stick human model, a change in pose, and the like, and perform extraction of a feature value of the movement (movement feature value) of the person, and classification (division by class) of the person included in an image, and the like. In the action analysis processing, it is also possible to estimate a body height of the person and to determine a position of the person in the image, by using the information of the stick human model. The action analysis processing can estimate, from the image, for example, an action such as pose changing or pose transitioning, traveling (change or transition of a position), and the like, and extract a movement feature value of the action.
(6) The appearance attribute analysis function can recognize an appearance attribute associated with a person. The appearance attribute analysis function performs extraction of a feature value (appearance attribute feature value) relating to the recognized appearance attribute, classification (division by class) of a person included in an image, and the like. The appearance attribute is an attribute on appearance of a person. The appearance attribute includes, for example, one or more of an age group, gender, a type and a color of clothing, a type and a color of shoes, a hairstyle, whether a hat is worn, whether a tie is worn, whether a pair of glasses is worn, whether an umbrella is carried, whether an umbrella is used, whether a pair of gloves is worn, and the like.
(7) The gradient feature analysis function extracts a feature value (gradient feature value) of a gradient in an image. For example, a technique such as SIFT, SURF, RIFF, ORB, BRISK, CARD, HOG, and the like can be applied to gradient feature detection processing. SIFT is an abbreviation for scale-invariant feature transform. SURF is an abbreviation for speeded-up robust features. RIFF is an abbreviation for rotation-invariant fast feature. BRIEF is an abbreviation for binary robust independent elementary features. ORB is an abbreviation for oriented fast and rotated brief. BRISK is an abbreviation for binary robust invariant scalable keypoints. CARD is an abbreviation for compact and real-time descriptors. HOG is an abbreviation for histograms of oriented gradients.
(8) The color feature analysis function can detect a physical object from an image, extract a feature value of a color (color feature value) of the detected physical object, and perform classification (division by class) and the like of the detected physical object. The color feature value is, for example, a color histogram and the like.
(9) The traffic line analysis function can determine a traffic line (trajectory of movement) of a person included in a video by using, for example, a result of identity determination in any one of the above-described analysis functions (2) to (6). In detail, for example, by connecting persons who are determined to be a same person between different images in a time series manner, a traffic line of the person can be determined. Note that, in a case where videos of different object regions captured by each of the plurality of capturing apparatuses 101 are acquired, and the like, the traffic line analysis function can also determine a traffic line that extends over the plurality of videos capturing the different object regions.

The above-described image feature value includes, for example, a result of detecting a physical object, a face feature value, a human body related feature value, a pose feature value, a movement feature value, an appearance attribute feature value, a gradient feature value, a color feature value, and a traffic line. Note that, each of the analysis functions (1) to (9) may use a result of analysis performed by another analysis function, as appropriate.

Note that, the information processing apparatus 103 may include the function of the analysis apparatus 102. In this case, the information processing system 100 may not include the function of the analysis apparatus 102.

### (Functional Configuration Example of Information Processing Apparatus 103 According to Example Embodiment 1)

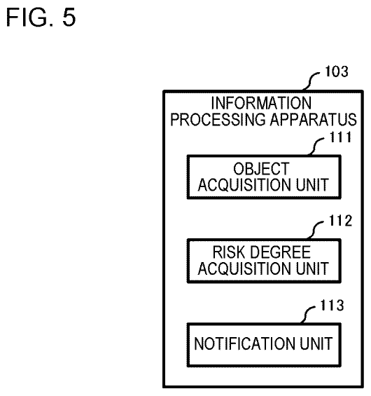

FIG. 5 is a diagram illustrating a functional configuration example of the information processing apparatus 103 according to the example embodiment 1. The information processing apparatus 103 is an apparatus for detecting a degree of risk in an object region by using analysis information being a result of analyzing a video. The information processing apparatus 103 functionally includes, for example, the object acquisition unit 111, the risk degree acquisition unit 112, and a notification unit 113.

The object acquisition unit 111 acquires analysis information, for example, from the analysis apparatus 102 via the network N. The object acquisition unit 111 acquires, by using the acquired analysis information, object information relating to an object.

As described above, the analysis information includes, for example, an image feature value of a physical object captured in a video. The analysis information may include a video from which the image feature value is generated.

The object is a physical object of a predefined type. The object according to the present example embodiment is an accommodating tool. The accommodating tool may be an item that can accommodate an item such as a dangerous object. In detail, for example, the accommodating tool is a bag, a backpack, a suitcase, a carry cart, a plastic bottle, a canteen, and the like. The dangerous object is, for example, an edged tool, a gun and a blade and other such weapons, a blunt instrument, a gun, a toxic drug, a combustible that can be easily ignited (for example, gasoline), and the like.

The object information is information relating to the object. The object information may be information that can be acquired by using the analysis information.

The object information according to the present example embodiment includes a position and a state of the accommodating tool.

A position of a container is, for example, information indicating a position in a video. The position of the container may be represented by, for example, a coordinate system being defined as appropriate for the video, such as a coordinate system used in the analysis processing of the video. Note that, the position of the container is not limited thereto, and may be, for example, a position in a real space determined from the position in the video, and the like.

A state of the container is, for example, information indicating a state of the container determined from analysis information relating to the container.

The risk degree acquisition unit 112 determines a degree of risk of the object by using the object information acquired by the object acquisition unit 111. The degree of risk of the object is an index such as a value indicating a degree of risk of the object. An example of a method in which the risk degree acquisition unit 112 determines the degree of risk of the object from the object information is described later.

The notification unit 113 notifies the degree of risk of the object determined by the risk degree acquisition unit 112.

### (Physical Configuration Example of Information Processing System 100 According to Example Embodiment 1)

The information processing system 100 is physically configured of the at least one capturing apparatus (for example, camera) 101, the analysis apparatus 102, and the information processing apparatus 103 connected to each other via the network N. Each of the apparatuses 101 to 103 is configured of a single physically distinct apparatus.

Note that, each of the analysis apparatus 102 and the information processing apparatus 103 may physically be configured of one apparatus. Further, any one or a plurality of the analysis apparatus 102 and the information processing apparatus 103 may physically be configured of a plurality of apparatuses connected to each other via an appropriate communication line such as the network N.

Each of the analysis apparatus 102 and the information processing apparatus 103 according to the present example embodiment may be physically configured in a similar manner. Herein, a physical configuration example is described with reference to a drawing, using the information processing apparatus 103 as an example.

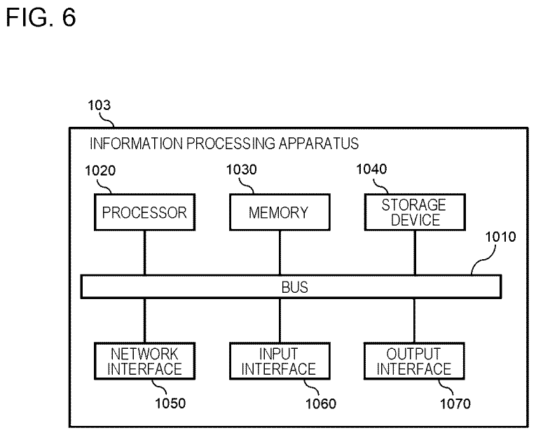

FIG. 6 is a diagram illustrating a physical configuration example of the information processing apparatus 103 according to the example embodiment 1. The information processing apparatus 103 physically includes, for example, a bus 1010, a processor 1020, a memory 1030, a storage device 1040, a network interface 1050, an input interface 1060, and an output interface 1070.

The bus 1010 is a data transmission path for the processor 1020, the memory 1030, the storage device 1040, the network interface 1050, the input interface 1060, and the output interface 1070 to mutually transmit and receive data. However, a method in which the processor 1020 and the like are connected to one another is not limited to bus connection.

The processor 1020 is a processor achieved by a central processing unit (CPU), graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module for achieving a function of the apparatus including the storage device 1040. The processor 1020 reads each program module into the memory 1030 and executes each program module, and thereby a function associated with the program module is achieved.

The network interface 1050 is an interface for connecting the apparatus including the network interface 1050 to the network N.

The input interface 1060 is an interface for a user to input information. The input interface 1060 is configured of, for example, one or a plurality of a touch panel, a keyboard, a mouse, and the like.

The output interface 1070 is an interface for providing information to a user. The output interface 1070 is configured of, for example, a liquid crystal panel, an organic electro-luminescence (EL) panel, and the like.

The configuration example of the information processing system 100 according to the example embodiment 1 has been described so far. In the following, operation of the information processing system 100 according to the present example embodiment is described.

### (Operation of Information Processing System 100 According to Example Embodiment 1)

The information processing system 100 according to the example embodiment 1 executes information processing including analysis processing and risk detection processing.

The analysis processing is processing for analyzing a video. The analysis processing is executed by the analysis apparatus 102. In the analysis processing, the analysis apparatus 102 the analysis apparatus 102 acquires at least one video from the capturing apparatus 101. The analysis apparatus 102 analyzes the acquired video, and generates analysis information including an image feature value and the like. The analysis processing is performed in real time, for example, by acquiring a video at any time. Note that, the analysis processing is not limited thereto, and may be performed, for example, by using a video that is captured in a predetermined period and is stored in an unillustrated storage unit. The predetermined period may be specified, for example, by a user.

### (Example of Risk Detection Processing According to Example Embodiment 1)

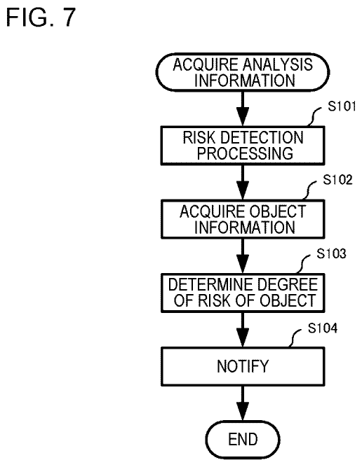

FIG. 7 is a flowchart illustrating an example of the risk detection processing according to the example embodiment 1. The risk detection processing is processing for detecting a degree of risk in an object region by using analysis information generated in the analysis processing. The risk detection processing is, for example, repeated in real time. Note that, the risk detection processing is not limited thereto, and may be performed by using analysis information generated based on a video captured in a predetermined period, for example, in response to an instruction from a user.

The object acquisition unit 111 acquires analysis information, for example, from the analysis apparatus 102 via the network N (step S101).

The object acquisition unit 111 acquires object information relating to an object by using the analysis information acquired in step S101 (step S102).

In detail, for example, the object is an item that can accommodate a dangerous object. Whether an accommodating tool can accommodate a dangerous object may be determined based on a size of a container. In this case, for example, the object acquisition unit 111 extracts, by using the analysis information, a container of a predetermined size or larger among physical objects detected from a video, and acquires object information relating to the extracted container.

The risk degree acquisition unit 112 determines a degree of risk of the object by using the object information acquired in step S102 (step S103).

In detail, for example, the risk degree acquisition unit 112 determines the degree of risk of the object by further using a predetermined risk degree determination criterion.

The risk degree determination criterion is information indicating a criterion for determining the degree of risk of the object. The risk degree determination criterion is, for example, preliminarily stored in the risk degree acquisition unit 112.

For example, the risk degree determination criterion associates one or a plurality of conditions with a degree of risk. The one or plurality of conditions in this case may be, for example, a condition to be satisfied by an object at an assumed risk or at a previous stage thereto. Further, the degree of risk in this case may be determined according to, for example, a possibility that a risk is occurring under the condition or a possibility that the risk becomes reality under the condition.

The risk degree acquisition unit 112 determines whether the object satisfies the one or a plurality of conditions, for example, by using the object information. Then, in a case where the object satisfies the condition, the risk degree acquisition unit 112 determines the degree of risk associated with the satisfied condition to be a degree of risk of the object.

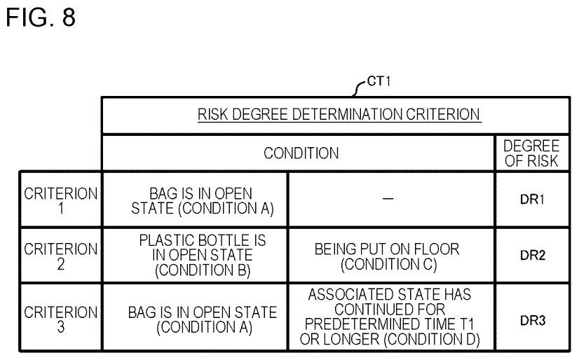

FIG. 8 is a diagram illustrating one example of a risk degree determination criterion CT1 according to the example embodiment 1. The risk degree determination criterion CT1 illustrated in FIG. 8 includes criteria 1 to 3. Note that, a risk degree determination criterion may include at least one criterion.

The criterion 1 associates a condition A with a degree of risk DR1. The criterion 2 associates conditions B and C with a degree of risk DR2. The criterion 3 associates conditions A and D with a degree of risk DR3. The conditions A and B are examples of a condition using a state of a container. The condition C is an example of a condition using a position of the container. The condition D is an example of a condition using a duration of an associated state.

In detail, the condition A indicates that a bag is in an open state. The condition A is a condition satisfied by, for example, a bag at a previous stage of an injury with an edged tool, and the like occurring.

Herein, being in an open state refers to being in a state in which a lid, a zipper, or the like of the container is open and an interior is exposed, and the same applies hereinafter.

The degree of risk DR1 may be set to, for example, an index such as a value according to a possibility that a risk of an injury with an edged tool, and the like occurring becomes a reality in a case where the bag is in the open state.

The condition B indicates that a plastic bottle is in an open state. The condition C indicates that a plastic bottle is put on a floor. The conditions B and C are conditions satisfied by, for example, a plastic bottle containing a dangerous object at a previous stage of being kicked, in order to splay a surrounding area with the dangerous object such as a poison or gasoline.

The degree of risk DR2 may be set to, for example, an index such as a value according to a possibility that a risk of the contained dangerous object being splayed becomes a reality in a case where the plastic bottle is put on the floor while being in the open state.

The condition D indicates that an associated state (the condition A in the example in FIG. 8) has continued for a predetermined time T1 or longer. The conditions A and D are conditions satisfied by, for example, a bag at a previous stage of an injury with an edged tool, and the like occurring.

The degree of risk DR3 may be set to, for example, an index such as a value according to a possibility that a risk of an injury with an edged tool, and the like occurring becomes a reality in a case where the bag has been in the open state continuously for the predetermined time T1 or longer.

In this example, similar acts are assumed as a risk in the criteria 1 and 3. Since opening a bag and taking out its content is also a normal practice, the condition A is likely to include a state of a bag according to such a normal act. In the criterion 3, such a possibility can be reduced by adding the condition D to the condition A. Thus, DR1 may be set to, for example, a value indicating a degree of risk being less than DR3.

Note that, the risk degree determination criterion is not limited to that described herein, and for example, an assumed risk and a previous stage thereto, a condition and a criterion to be satisfied by an object at the assumed risk or at the previous stage thereto, and the like are not limited to the above-described example. For example, a condition that a plastic bottle contains liquid may be further added to the criterion 2.

In a case where the risk degree determination criterion illustrated in FIG. 8 is used, the risk degree acquisition unit 112 determines whether an object satisfies any of the condition A, the conditions B and C, and the conditions A and D, for example, by using the object information.

Then, in a case where an object satisfies any of the conditions, the risk degree acquisition unit 112 determines a degree of risk associated with the satisfied condition to be a degree of risk of the object.

For example, in a case where a bag satisfies the condition A, the risk degree acquisition unit 112 determines DR1 as a degree of risk of the bag. In a case where a plastic bottle satisfies the conditions B and C, the risk degree acquisition unit 112 determines DR2 as a degree of risk of the plastic bottle. In a case where a bag satisfies the conditions A and D, the risk degree acquisition unit 112 determines DR3 as a degree of risk of the bag.

Note that, in a case where the conditions of the criterion 3 (conditions A and D) are satisfied, the condition of the criterion 1 (condition A) is also satisfied. With respect to a condition included in two criteria, in a case where a condition of one criterion (for example, the condition A of the criterion 1) includes a condition of the other criterion (for example, the conditions A and D of the criterion 3), the criterion including the included condition (for example, the criterion 3) may be applied with priority. Specifically, in such a case, the risk degree acquisition unit 112 determines a degree of risk (for example, DR3) associated with the included condition (for example, the criterion 3) to be a degree of risk of the object.

Refer again to FIG. 7.

The notification unit 113 notifies the degree of risk of the object determined in step S103 (step S104), and ends the risk detection processing.

A method of notification may vary. The method of notification may be, for example, one or more of sound, display, and the like.

In a case where the notification is performed by sound, the notification unit 113 may notify while changing a mode of the sound (type, pitch, volume, and the like) according to a magnitude of the determined degree of risk.

In a case where the notification is performed by display, the notification unit 113 may display a screen in which a mark indicating an object is superimposed on a video in which the object is captured. The mark may be defined as appropriate, and may be, for example, a frame of a predetermined shape (for example, rectangle, circle, oval, and the like) surrounding the object, an arrow pointing to the object, a figure associated with the object, and the like. In a case where a frame is employed as the mark, the notification unit 113 may display while changing, for example, a mode of the frame (a line type, a line thickness, a line color, and the like) according to a magnitude of the determined degree of risk.

Further, in a case where the determined degree of risk is equal to or greater than a threshold value, the notification unit 113 may notify, by using sound, display, or the like, that an object of which degree of risk is equal to or greater than a predetermined value is detected.

According to such risk detection processing, the object information includes a position and a state of an accommodating tool, and therefore a degree of risk of the accommodating tool can be determined by using both the position and the state of the accommodating tool. Further, with notification performed, a user and the like can easily recognize the determined degree of risk.

### (Action and Advantageous Effect)

As described above, according to the present example embodiment, the information processing apparatus 103 includes the object acquisition unit 111, and the risk degree acquisition unit 112.

The object acquisition unit 111 acquires object information relating to an object captured in a video, by using analysis information acquired by analyzing the video capturing an object region. The risk degree acquisition unit 112 determines a degree of risk of the object by using the object information. The object information includes a position and a state of an accommodating tool.

Thereby, a degree of risk of the accommodating tool can be determined by using both the position and the state of the accommodating tool. Thus, it is possible to detect a degree of risk in the object region with high accuracy.

### Example Embodiment 2

In an example embodiment 2, an example in which an object includes an item other than a container, and a person, is described.

In the present example embodiment, for a sake of simplicity of description, description overlapping with that of the example embodiment 1 is omitted as appropriate.

An information processing system according to the example embodiment 2 includes an information processing apparatus 203 that substitutes the information processing apparatus 103 according to the example embodiment 1. Except for this, the information processing system according to the present example embodiment may be configured similarly to the information processing system 100 according to the example embodiment 1.

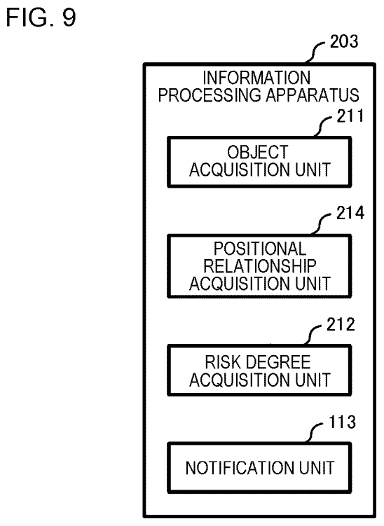

FIG. 9 is a diagram illustrating a functional configuration example of the information processing apparatus 203 according to the example embodiment 2. The information processing apparatus 203 functionally includes, for example, an object acquisition unit 211 and a risk degree acquisition unit 212 instead of the object acquisition unit 111 and the risk degree acquisition unit 112 according to the example embodiment 1. Further, the information processing apparatus 203 functionally includes, for example, a positional relationship acquisition unit 214, and a notification unit 113 similar to that in the example embodiment 1.

Similarly to the object acquisition unit 111 according to the example embodiment 1, the object acquisition unit 211 acquires object information relating to an object by using analysis information acquired from an analysis apparatus 102.

The object according to the present example embodiment includes an item including a container, and a person.

The object information according to the present example embodiment includes a position and an attribute of an item, and a position and an attribute of a person.

The position of the item and the position of the person may be similar to the position of the container described in the example embodiment 1, and for example, are information indicating a position of each of the item and the person in a video.

The attribute of the item includes a state of an accommodating tool. The attribute of the item may include at least one of a state of an item other than an accommodating tool, a pose of an item including an accommodating tool, and the like. Note that, the attribute of the item is not limited thereto.

The attribute of the person may include at least one of a movement of the person, a moving velocity of the person, a pose of the person, whether the person wears an item to be worn, and a state of the item to be worn.

For example, the item to be worn is a glove, and a state of the item to be worn in this case is that the glove is worn only on either one of left or right hand (symmetry of the item to be worn). This is because, for example a globe may be worn only on one hand that holds a plastic bottle containing a dangerous object.

The attribute of the person may include, for example, not holding an item in at least one hand, holding an item in only one hand, and the like. Note that, the attribute of the person is not limited thereto.

The positional relationship acquisition unit 214 determines a positional relationship of objects by using the object information. In a case where a plurality of objects are captured in a video (specifically, positions of the plurality of objects are included in the object information), the positional relationship acquisition unit 214 may determine a positional relationship of the objects.

The positional relationship of the objects is, for example, a positional relationship of each pair of the plurality of objects. In detail, for example, the positional relationship of the objects is a positional relationship of an item and a person, a positional relationship of persons in a case where the plurality of persons are included in the video, and the like.

The positional relationship of an item and a person is, for example, a relationship that the person holds the item such as an accommodating tool, a plastic bottle, and the like. The positional relationship of an item and a person is, for example, a relationship that the person holds the item such as a bag, a backpack, and the like, in front of the person. The positional relationship of an item and a person is, for example, a relationship that a plastic bottle is put at feet of the person, a relationship that a plastic bottle is put at feet and in front of the person, and the like. Being put at feet is one example of being within a predetermined range from a person. Note that, the positional relationship of an item and a person is not limited thereto.

Similarly to the risk degree acquisition unit 112 according to the example embodiment 1, the risk degree acquisition unit 212 determines a degree of risk of the object by using the object information acquired by the object acquisition unit 211.

The degree of risk of the object according to the present example embodiment includes at least one of a degree of risk of an item (including a degree of risk of an accommodating tool.), a degree of risk of a person, and a degree of risk of a combination of the item (including an accommodating tool) and the person.

The risk degree acquisition unit 212 according to the present example embodiment may determine the degree of risk the object by further using a positional relationship of the objects acquired by the positional relationship acquisition unit 214. Specifically, the risk degree acquisition unit 212 may determine the degree of risk of the object by using the object information and the positional relationship of the objects in a case where a plurality of the objects are captured in a video.

The functional configuration example of the information processing system according to the example embodiment 2 has been described so far. The information processing system according to the present example embodiment may be physically configured in a similar manner as in the information processing system 100 according to the example embodiment 1. In the following, an operation example of the information processing system according to the present example embodiment is described.

### (Operation of Information Processing System According to Example Embodiment 2)

Similarly to the information processing system 100 according to the example embodiment 1, the information processing system according to the example embodiment 2 executes information processing including analysis processing and risk detection processing.

The analysis processing may be similar to that in the example embodiment 1. The risk detection processing according to the present example embodiment is processing that substitutes the risk detection processing according to the example embodiment 1. In the following, the risk detection processing according to the present example embodiment is described with reference to drawings.

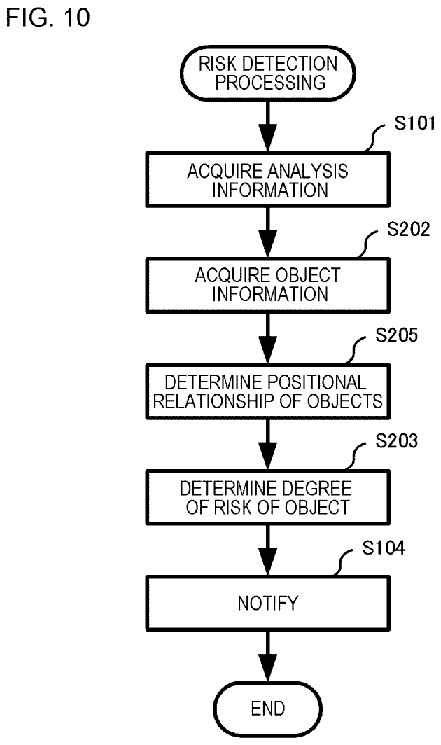

FIG. 10 is a flowchart illustrating an example of the risk detection processing according to the example embodiment 2.

The object acquisition unit 211 executes step S101 similar to that in the example embodiment 1.

Similarly to the example embodiment 1, the object acquisition unit 211 acquires object information relating to an object by using analysis information acquired in step S101 (step S202).

The object information acquired in step S202 according to the present example embodiment includes a position and an attribute of an item, and a position and an attribute of a person.

In a case where the object information acquired in step S202 includes positions of a plurality of the objects, the positional relationship acquisition unit 214 determines a positional relationship of the objects (step S205).

In detail, for example, the positional relationship acquisition unit 214 determines whether positions of a plurality of the objects are included in the object information acquired in step S202. In a case where the positions of the plurality of objects are included in the object information, the positional relationship acquisition unit 214 determines a positional relationship between the plurality of objects. In a case where the positions of the plurality of objects are not included in the object information, the positional relationship acquisition unit 214 does not execute step S205, and next step S203 is executed.

The risk degree acquisition unit 212 determines a degree of risk of the object by using the object information and the positional relationship acquired in steps S202 and S205 (step S203).

In detail, for example, in a case where the positional relationship of the objects is not acquired in step S205, the risk degree acquisition unit 212 determines a degree of risk of the object by using the object information acquired in step S202. In a case where the positional relationship of the objects is acquired in step S205, the risk degree acquisition unit 212 determines the degree of risk of the object by using the object information and the positional relationship acquired in steps S202 and S205.

Similarly to the risk degree acquisition unit 112 according to the example embodiment 1, the risk degree acquisition unit 212 may determine the degree of risk of the object by further using a predetermined risk degree determination criterion. The risk degree determination criterion according to the present example embodiment may include a positional relationship of the objects, as a condition.

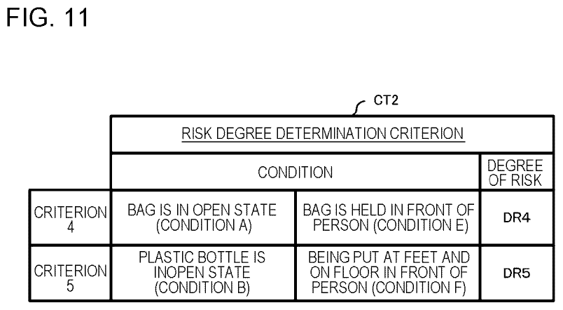

FIG. 11 is a diagram illustrating one example of a risk degree determination criterion CT2 according to the example embodiment 2. The risk degree determination criterion CT2 illustrated in FIG. 11 includes a criterion 4 and a criterion 5. Note that, the risk degree determination criterion CT2 is not limited to that described herein.

The criterion 4 associates conditions A and E with a degree of risk DR4. The criterion 5 associates conditions B and F with a degree of risk DR5. The conditions E and F are examples of a condition using a positional relationship of an item and a person. Specifically, the condition F is an example of a condition using a positional relationship of an item and a person “at feet and in front of a person” and a state of the item “being put on a floor”.

Similarly to the condition A or the combination of the conditions A and D described in the example embodiment 1, the conditions A and E are, for example, conditions satisfied by a bag at a previous stage of an injury with an edged tool, and the like occurring.

The degree of risk DR4 may be set to, for example, an index such as a value according to a possibility that a risk of an injury with an edged tool, and the like occurring becomes a reality in a case where a person holds a bag in front while the bag is in an open state.

Similarly to the combination of the conditions B and C described in the example embodiment 1, the conditions B and F are conditions satisfied by, for example, a plastic bottle containing a dangerous object at a previous stage of being kicked, in order to splay a surrounding area with the dangerous object such as a poison or gasoline.

The degree of risk DR5 may be set to, for example, an index such as a value according to a possibility that a risk of the contained dangerous object being splayed becomes a reality in a case where a plastic bottle is in the open state, and put at feet of a person and on a floor in front of the person.

In a case where the risk degree determination criterion CT2 illustrated in FIG. 11 is used, the risk degree acquisition unit 212 determines whether the object satisfies any of the conditions A and E, and the conditions B and F, for example, by using the object information and the positional relationship of the objects.

Then, in a case where the object satisfies any of the conditions, the risk degree acquisition unit 212 determines a degree of risk associated with the satisfied condition to be a degree of risk of the object.

For example, in a case where a bag satisfies the conditions A and E, the risk degree acquisition unit 212 determines DR4 to be a degree of risk of the bag. In a case where a plastic bottle satisfies the conditions B and F, the risk degree acquisition unit 212 determines DR5 to be a degree of risk of the plastic bottle.

Note that, the degree of risk DR4 in a case where the criterion 4 is used may be determined as a degree of risk of a person who satisfies the conditions included in the criterion 4, or may be determined as a degree of risk of a combination of a person and a bag that satisfy the conditions included in the criterion 4. Similarly for the criterion 5, the degree of risk DR5 may be determined as a degree of risk of a person who satisfies the conditions included in the criterion 5, or may be determined as a degree of risk of a combination of a person and a plastic bottle that satisfy the conditions included in the criterion 5.

Refer FIG. 10 again.

Similarly to the example embodiment 1, the notification unit 113 notifies the degree of risk of the object determined in step S203 (step S104), and ends the risk detection processing.

According to such risk detection processing, a degree of risk of the object can be determined further using the positional relationship of the objects including an item and a person.

### (Action and Advantageous Effect)

As described above, according to the present example embodiment, an object further includes a person. Object information further includes a position of the person. The risk degree acquisition unit 212 determines, by using the object information, a degree of risk of either an accommodating tool or the person, or a combination of the accommodating tool and the person.

Thereby, a degree of risk of the object (either the accommodating tool or the person, or the combination of the accommodating tool and the person) can be determined further using a positional relationship of the accommodating tool and the person. Thus, it is possible to detect a degree of risk in an object region with high accuracy.

According to the present example embodiment, the object information includes a position and an attribute of an item including an accommodating tool, and a position and an attribute of a person. The attribute of the item includes a state of the accommodating tool. The attribute of the person includes at least one of a movement of the person, a pose of the person, whether the person wears an item to be worn and a state of the item to be worn.

Thereby, a degree of risk of the object can be determined by using various types of information on the item and the person, such as the positions and the attributes of the item and the person. Thus, it is possible to detect a degree of risk in the object region with high accuracy.

According to the present example embodiment, the risk degree acquisition unit 212 determines a degree of risk of the object by using the object information and the positional relationship of the objects.

Thereby, the degree of risk of the object can be determined further using the positional relationship of the objects. Thus, it is possible to detect a degree of risk in the object region with high accuracy.

### Example Embodiment 3

In an example embodiment 3, an example in which a degree of risk of an object is determined in a case where a precondition is satisfied is described. Further, in the present example embodiment, an example in which sensor information generated by a sensor apparatus is used for the precondition is described.

In the present example embodiment, for a sake of simplicity of description, description overlapping with that of the other example embodiments is omitted as appropriate.

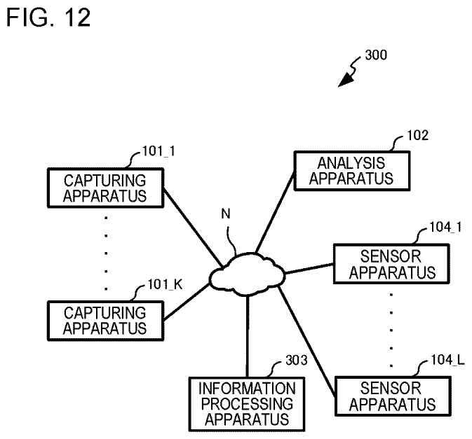

FIG. 12 is a diagram illustrating a configuration example of an information processing system 300 according to the example embodiment 3. The information processing system 300 includes at least one capturing apparatus 101 and an analysis apparatus 102 similar to those in the example embodiment 1, and an information processing apparatus 303 that substitutes the information processing apparatus 103 according to the example embodiment 1. The information processing system 300 further includes at least one of sensor apparatuses 104_1 to 104_L.

L is an integer equal to or greater than one. In a case where the sensor apparatuses 104_1 to 104_L are not particularly distinguished from each other, the sensor apparatuses 104_1 to 104_L are also referred to as a “sensor apparatus 104”.

The at least one capturing apparatus 101, the analysis apparatus 102, the information processing apparatus 103, and the at least one sensor apparatus 104 are connected to each other via a network N similar to that in the example embodiment 1, and mutually transmit and receive information via the network N.

The sensor apparatus 104 includes one or a plurality of sensors, and generates sensor information detected by each of the one or plurality of sensors. The sensor apparatus 104 transmits the generated sensor information to the information processing apparatus 303.

The sensor is one or a plurality of a sound sensor for detecting sound such as a scream and angry voice, a heat sensor for detecting heat such as flame during a fire, and an odor sensor for detecting an odor of a toxic drug, a combustible (for example, gasoline), and the like.

### (Functional Configuration Example of Information Processing Apparatus 303 According to Example Embodiment 3)

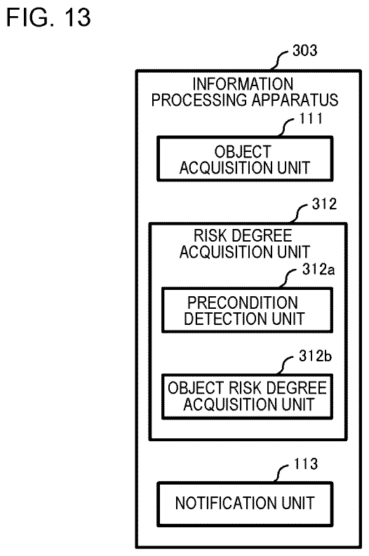

FIG. 13 is a diagram illustrating a functional configuration example of the information processing apparatus 303 according to the example embodiment 3. The information processing apparatus 303 functionally includes, for example, a risk degree acquisition unit 312 that substitutes the risk degree acquisition unit 112 according to the example embodiment 1. Except for this point, the information processing apparatus 303 may be configured similarly to the information processing apparatus 103 according to the example embodiment 1. Note that, the information processing apparatus 303 may include an object acquisition unit 211 similar to that in the example embodiment 2, instead of an object acquisition unit 111.

In a case where a predetermined precondition is detected, the risk degree acquisition unit 312 determines a degree of risk of an object by using object information. The precondition is that, for example, one or more of a sound of a predetermined volume or louder, heat of a predetermined temperature or hotter, and a predetermined odor are detected.

In detail, for example, the risk degree acquisition unit 312 includes a premise detection unit 312a, and an object risk degree acquisition unit 312b.

The premise detection unit 312a detects the predetermined precondition by using at least one of the sensor information and the object information. In the present example embodiment, an example in which the premise detection unit 312a detects the predetermined precondition by using the sensor information is described later.

In a case where the predetermined precondition is detected, the object risk degree acquisition unit 312b determines a degree of risk of the object by using the object information.

The functional configuration example of the information processing system 300 according to the example embodiment 3 has been described so far. The information processing system 300 according to the present example embodiment may be physically configured of the apparatuses 101, 102, and 303 configured similarly to the information processing system 100 according to the example embodiment 1, and the sensor apparatus 104 including various sensors. In the following, an operation example of the information processing system according to the present example embodiment is described.

### (Operation of Information Processing System 300 According to Example Embodiment 3)

Similarly to the information processing system 100 according to the example embodiment 1, the information processing system 300 according to the example embodiment 3 executes information processing including analysis processing and risk detection processing. The analysis processing may be similar to that in the example embodiment 1. The risk detection processing according to the present example embodiment is processing that substitutes the risk detection processing according to the example embodiment 1. In the following, the risk detection processing according to the present example embodiment is described with reference to a drawing.

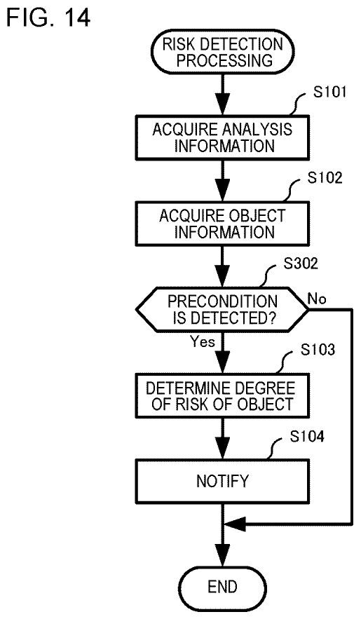

FIG. 14 is a flowchart illustrating an example of the risk detection processing according to the example embodiment 3.

Steps S101 to S102 similar to those in the example embodiment 1 are executed.

The premise detection unit 312a detects a predetermined precondition by using sensor information (step S302).

In detail, for example, the premise detection unit 312a acquires the sensor information from the sensor apparatus 104, via the network N. The premise detection unit 312a determines whether the acquired sensor information satisfies the predetermined precondition. In a case where the sensor information satisfies the precondition, the premise detection unit 312a determines that the precondition is detected. In a case where the sensor information does not satisfy the precondition, the premise detection unit 312a determines that the precondition is not detected.

In a case where the precondition is detected (step S302; Yes), the object risk degree acquisition unit 312b determines a degree of risk of an object by using object information acquired in step S102 similarly to the example embodiment 1 (step S103). Then, a notification unit 113 executes step S104 similar to that in the example embodiment 1, and ends the risk detection processing. In a case where the precondition is not detected (step S302; No), the object risk degree acquisition unit 312b ends the risk detection processing.

### (Action and Advantageous Effect)

As described above, according to the present example embodiment, in a case where a predetermined precondition is detected, the risk degree acquisition unit 312 determines a degree of risk of an object by using object information.

Thereby, a degree of risk of the object can be determined on a condition that the precondition is satisfied. Thus, it is possible to detect a degree of risk in an object region with higher accuracy.

According to the present example embodiment, the risk degree acquisition unit 312 includes the premise detection unit 312a, and the object risk degree acquisition unit 312b. The premise detection unit 312a detects the predetermined precondition by using at least one of sensor information and the object information. In a case where the predetermined precondition is detected, the object risk degree acquisition unit 312b determines a degree of risk of the object by using the object information.

Thereby, a degree of risk of the object can be determined on a condition that the precondition is satisfied. Thus, it is possible to detect a degree of risk in the object region with higher accuracy.

### Modification Example 1

Sensor information may be used in a risk degree determination criterion, as a condition for determining a degree of risk.

Further, a precondition may include a condition detected by using object information or information acquired from the object information. Specifically, the risk degree acquisition unit 112 may detect the predetermined precondition by using at least one of the sensor information and the object information. An example of such a precondition includes a to d in the following.

A precondition a is that a reciprocal relationship of a physical object (at least one of a person and an item) and a crowd satisfies a criterion. In detail, for example, the precondition a is that there is a person who is looked at by a plurality of persons within a predetermined distance, there is a person who is surrounded by a plurality of persons at a predetermined distance (encircling), and the like.

A precondition b is that there is a person looking in a direction of a surveillance camera. In detail, for example, the person looking in the direction of the surveillance camera is a person who is eye-to-eye with the surveillance camera.

A precondition c is that a frequency or a percentage (for example, a percentage in time) at which a face can be detected is smaller than a standard value by a predetermined value in the object region. This is an example in which the precondition is a movement to avoid capturing the face.

A precondition d is that there is a person who commits an act being prohibited in the object region. In detail, for example, the act being prohibited in the object region is taking out a cigarette on a train. This is an example in which the precondition is a movement that may trigger a dispute.

The present modification example also achieves an advantageous effect similar to that in the example embodiment 3.

### Example Embodiment 4

In an example embodiment 4, an example in which a degree of risk of an object is determined by further using a history of object information is described.

In the present example embodiment, for a sake of simplicity of description, description overlapping with that of other example embodiments is omitted as appropriate.

An information processing system according to the example embodiment 4 includes an information processing apparatus 403 that substitutes the information processing apparatus 103 according to the example embodiment 1. Except for this, the information processing system according to the present example embodiment may be configured similarly to the information processing system 100 according to the example embodiment 1.

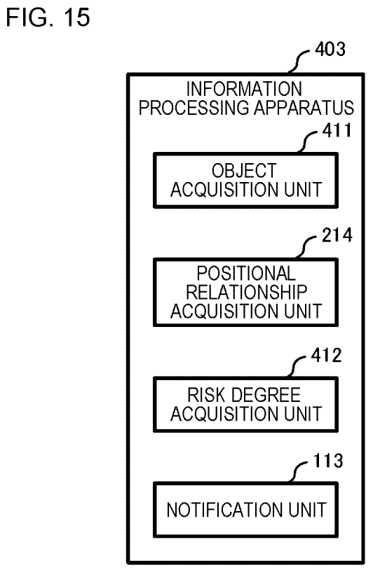

FIG. 15 is a diagram illustrating a functional configuration example of the information processing apparatus 403 according to the example embodiment 4. The information processing apparatus 403 functionally includes, for example, an object acquisition unit 411, and a risk degree acquisition unit 412. The information processing apparatus 403 functionally further includes, for example, a positional relationship acquisition unit 214 similar to that in the example embodiment 2, and a notification unit 113 similar to that in the example embodiment 1.

Similarly to the object acquisition unit 211 according to the example embodiment 2, the object acquisition unit 411 acquires object information relating to an object by using analysis information acquired from an analysis apparatus 102.

Specifically, similarly to that in the example embodiment 2, the object according to the present example embodiment includes an item including a container, and a person. Further, similarly to that in the example embodiment 2, the object information according to the present example embodiment includes a position and an attribution of an item, and a position and an attribution of a person.

The object acquisition unit 411 according to the present example embodiment stores the acquired object information. Specifically, the object acquisition unit 411 according to the present example embodiment stores a history of the object information. The history of the object information is, for example, information that associates the object information with a time at which a video from which the object information is generated is captured.

Note that, the object and the object information may be similar to those in the example embodiment 1. The object acquisition unit 411 may include a function similar to that of the object acquisition unit 111 according to the example embodiment 1, and store a history of object information similar to that in the example embodiment 1.

Similarly to the risk degree acquisition unit 212 according to the example embodiment 2, the risk degree acquisition unit 412 determines a degree of risk of the object by using the object information acquired by an object acquisition unit 211 and a positional relationship of the objects acquired by the positional relationship acquisition unit 214.

The risk degree acquisition unit 412 according to the present example embodiment determines a degree of risk of the object by further using the history of the object information.

Note that, the risk degree acquisition unit 412 may determine the degree of risk of the object by using object information similar to that in the example embodiment 1 and a history of the object information.

The functional configuration example of the information processing system according to the example embodiment 4 has been described so far. The information processing system according to the present example embodiment may be physically configured in a similar manner as in the information processing system 100 according to the example embodiment 1. In the following, an operation example of the information processing system according to the present example embodiment is described.

### (Operation of Information Processing System According to Example Embodiment 4)

Similarly to the information processing system 100 according to the example embodiment 1, the information processing system according to the example embodiment 4 executes information processing including analysis processing and risk detection processing.

The analysis processing may be similar to that in the example embodiment 1. The risk detection processing according to the present example embodiment is processing that substitutes the risk detection processing according to the example embodiment 1. In the following, the risk detection processing according to the present example embodiment is described with reference to drawings.

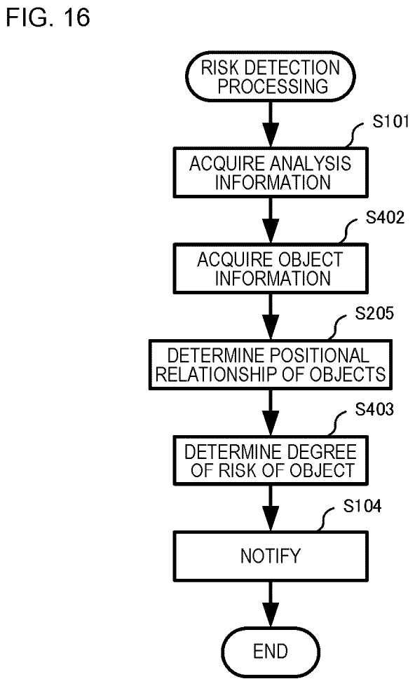

FIG. 16 is a flowchart illustrating an example of the risk detection processing according to the example embodiment 4.

The object acquisition unit 411 executes step S101 similar to that in the example embodiment 1.

Similarly to the example embodiment 1, the object acquisition unit 411 acquires object information relating to an object by using analysis information acquired in step S101, and stores the acquired object information (step S402).

Similarly to the example embodiment 2, in a case where the object information acquired in step S402 includes positions of a plurality of the objects, the positional relationship acquisition unit 214 determines a positional relationship of the objects (step S205).

Note that, the positional relationship acquisition unit 214 may store a history of the positional relationship of the objects. The history of the positional relationship of the objects is, for example, information that associates the positional relationship of the objects with a time at which a video from which the positional relationship of the objects is generated.

The risk degree acquisition unit 412 determines a degree of risk of the object by using a history of the object information, in addition to the object information and the positional relationship acquired in steps S402 and S205 (step S403).

In detail, for example, similarly to the risk degree acquisition unit 112 according to the example embodiment 1, the risk degree acquisition unit 412 may determine a degree of risk of the object by further using a predetermined risk degree determination criterion. The risk degree determination criterion according to the present example embodiment may include a condition that uses at least a part of the history of the object information.

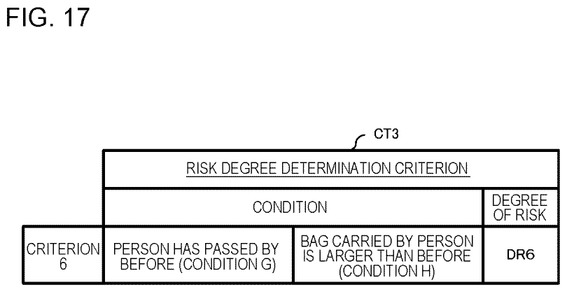

FIG. 17 is a diagram illustrating one example of a risk degree determination criterion CT3 according to the example embodiment 4. The risk degree determination criterion CT3 illustrated in FIG. 17 includes a criterion 6.

The criterion 6 associates conditions G and H with a degree of risk DR6. The conditions G and H are examples of a condition using a history of object information relating to an item and a person. The condition G is an example of a condition using a history relating to a person “the person has passed by before.” The condition H is an example of a condition using a history relating to an item (a container) “a bag carried by a person is larger than before.”

The conditions G and H are, for example, conditions satisfied by a person who, after preliminarily inspecting a site, intends to conduct a dangerous act at the site using a dangerous object such as a knife kept in a bag. Carrying a bag larger than before indicates that the bag is likely to contain a dangerous object.

DR6 may be set to, for example, an index such as a value according to a possibility that a risk becomes a reality in a case where a person who has passed by before carries a bag larger than before.

In a case where the risk degree determination criterion CT3 illustrated in FIG. 17 is used, the risk degree acquisition unit 412 determines whether the object satisfies the conditions G and H, for example, by using the object information, the positional relationship of the objects, and the history of the object information.

Then, in a case where the object satisfies a condition (specifically, in the present example embodiment, the conditions G and H), the risk degree acquisition unit 412 determines a degree of risk associated with the satisfied condition (specifically, in the present example embodiment, DR6) to be a degree of risk of the object.

Note that, the risk degree determination criterion CT3 is not limited to that described herein, and may include, for example, the condition G only. Further, the risk degree determination criterion CT3 may include a condition using the history of the positional relationship of the objects. In this case, the risk degree acquisition unit 412 may determine a degree of risk of the object by further using the history of the positional relationship of the objects.

### Refer to FIG. 16 Again.

Similarly to the example embodiment 1, the notification unit 113 notifies the degree of risk of the object determined in step S403 (step S104), and ends the risk detection processing.

According to such risk detection processing, a degree of risk of the object can be determined further using the history of the object information.

### (Action and Advantageous Effect)

As described above, according to the present example embodiment, the risk degree acquisition unit 412 determines a degree of risk of an object by further using a history of object information.

Thereby, a degree of risk of the object can be determined with even higher accuracy by further using the history of the object information. Thus, it is possible to detect a degree of risk in an object region with higher accuracy.

While the example embodiments and the modification example of the present invention have been described above with reference to the drawings, these are examples of the present invention, and various configurations other than those described above can also be adopted.

Further, although a plurality of steps (pieces of processing) are described in order in a plurality of flowcharts used in the above description, execution order of the steps executed in each of the example embodiments is not limited to the described order. In each of the example embodiments, the illustrated order of the steps may be changed within an extent that contents of the steps are not interfered. Further, the above-described example embodiments and the modification example may be combined within an extent that contents thereof do not conflict.

Some or all of the above-described example embodiments may be described as the following supplementary notes, but are not limited thereto.
1.

An information processing apparatus including:
an object acquisition unit that acquires object information relating to an object captured in a video, by using analysis information acquired by analyzing the video capturing an object region; and
a risk degree acquisition unit that determines a degree of risk of the object by using the object information, wherein
the object information includes a position and a state of an accommodating tool.
2.

The information processing apparatus according to supplementary note 1, wherein
the object further includes a person,
the object information further includes a position of the person, and
the risk degree acquisition unit determines a degree of risk of either the accommodating tool or the person, or a degree of risk of a combination of the accommodating tool and the person by using the object information.
3.

The information processing apparatus according to supplementary note 2, wherein
the object information includes a position and an attribute of an item including the accommodating tool, and a position and an attribute of the person,
the attribute of the item includes a state of the accommodating tool, and
the attribute of the person includes at least one of a movement of the person, a pose of the person, whether the person wears an item to be worn, and a state of the item to be worn.
4.

The information processing apparatus according to any one of supplementary notes 1 to 3, wherein
the risk degree acquisition unit determines a degree of risk of the object by using the object information and a positional relationship of the objects.
5.

The information processing apparatus according to any one of supplementary notes 1 to 4, wherein,
in a case where a predetermined precondition is detected, the risk degree acquisition unit determines a degree of risk of the object by using the object information.
6.

The information processing apparatus according to supplementary note 5, wherein
the risk degree acquisition unit includes
a precondition detection unit that detects the predetermined precondition by using at least one of sensor information and the object information, and
an object risk degree acquisition unit that determines, in a case where the predetermined precondition is detected, a degree of risk of the object by using the object information.
7.

The information processing apparatus according to any one of supplementary notes 1 to 6, wherein
the risk degree acquisition unit determines a degree of risk of the object by further using a history of the object information.
8.

An information processing system including:
the information processing apparatus according to any one of supplementary notes 1 to 7;
at least one capturing apparatus that generates a video by capturing the object region; and
an analysis apparatus that generates the analysis information by analyzing a video generated by the at least one capturing unit.
9.

An information processing method including,
by one or more computers:
acquiring object information relating to an object captured in a video, by using analysis information acquired by analyzing the video capturing an object region; and
determining a degree of risk of the object by using the object information, wherein
the object information includes a position and a state of an accommodating tool.
10.

The information processing method according to supplementary note 9, wherein
the object further includes a person,
the object information further includes a position of the person, and,
in the determination of a degree of risk, a degree of risk of either the accommodating tool or the person, or a degree of risk of a combination of the accommodating tool and the person is determined by using the object information.
11.

The information processing method according to supplementary note 10, wherein
the object information includes a position and an attribute of an item including the accommodating tool, and a position and an attribute of the person,
the attribute of the item includes a state of the accommodating tool, and
the attribute of the person includes at least one of a movement of the person, a pose of the person, whether the person wears an item to be worn and a state of the item to be worn.
12.

The information processing method according to any one of supplementary notes 9 to 11, wherein,
in the determination of a degree of risk, a degree of risk of the object is determined by using the object information and a positional relationship of the objects.
13.

The information processing method according to any one of supplementary notes 9 to 12, wherein,
in the determination of a degree of risk, a degree of risk of the object is determined in a case where a predetermined precondition is detected, by using the object information.
14.

The information processing method according to supplementary note 13, wherein,
in the determination of a degree of risk,
the predetermined precondition is detected by using at least one of sensor information and the object information, and,
in a case where the predetermined precondition is detected, a degree of risk of the object is determined by using the object information.
15.

The information processing method according to any one of supplementary notes 9 to 14, wherein,
in the determination of a degree of risk, a degree of risk of the object is determined by further using a history of the object information.
16.

A program for causing one or more computers to execute:
acquisition of object information relating to an object captured in a video, by using analysis information acquired by analyzing the video capturing an object region; and
determination of a degree of risk of the object, by using the object information, wherein
the object information includes a position and a state of an accommodating tool.
17.

The program according to supplementary note 16, wherein
the object further includes a person,
the object information further includes a position of the person, and,
in the determination of a degree of risk, a degree of risk of either the accommodating tool or the person, or a degree of risk of a combination of the accommodating tool and the person is determined by using the object information.
18.

The program according to supplementary note 17, wherein
the object information includes a position and an attribute of an item including the accommodating tool, and a position and an attribution of the person,
the attribute of the item includes a state of the accommodating tool, and
the attribute of the person includes at least one of a movement of the person, a pose of the person, whether the person wears an item to be worn, and a state of the item to be worn.
19.

The program according to any one of supplementary notes 16 to 18, wherein,
in the determination of a degree of risk, a degree of risk of the object is determined by using the object information and a positional relationship of the objects.

The program according to any one of supplementary notes 16 to 19, wherein,
in the determination of a degree of risk, a degree of risk of the object is determined in a case where a predetermined precondition is detected, by using the object information.
21.

The program according to supplementary note 20, wherein,
in the determination of a degree of risk,
the predetermined precondition is detected by using at least one of sensor information and the object information, and,
in a case where the predetermined precondition is detected, a degree of risk of the object is determined by using the object information.
22.

The program according to any one of supplementary notes 16 to 21, wherein,
in the determination of a degree of risk, a degree of risk of the object is determined by further using a history of the object information.
23

A medium recording the program according to any one of supplementary notes 16 to 22.

This application is based upon and claims the benefit of priority from Japanese patent application No. 2022-211664, filed on Dec. 28, 2022, the disclosure of which is incorporated herein in its entirety by reference.

### REFERENCE SIGNS LIST

100, 300 Information processing system
101 Capturing apparatus
102 Analysis apparatus
103, 203, 303, 403 Information processing apparatus
104 Sensor apparatus
111, 211, 411 Object acquisition unit
112, 212, 312, 412 Risk degree acquisition unit
113 Notification unit
214 Positional relationship acquisition unit
312a Precondition detection unit
312b Object risk degree acquisition unit
CT1 to CT5 Risk degree determination criterion

What is claimed is:

1. An information processing apparatus comprising:
at least one memory configured to store instructions; and
at least one processor configured to execute the instructions to:
acquire object information relating to an object captured in a video, by using analysis information acquired by analyzing the video capturing an object region; and
determine a degree of risk of the object by using the object information, wherein
the object information includes a position and a state of an accommodating tool.

2. The information processing apparatus according to claim 1, wherein
the object further includes a person,
the object information further includes a position of the person, and
the at least one processor is configured to execute the instructions to determine the degree of risk of either the accommodating tool or the person by using the object information, or the degree of risk of a combination of the accommodating tool and the person by using the object information.

3. The information processing apparatus according to claim 2, wherein
the object information includes a position and an attribute of an item including the accommodating tool, and a position and an attribute of the person,
the attribute of the item includes a state of the accommodating tool, and
the attribute of the person includes at least one of a movement of the person, a pose of the person, whether the person wears an item to be worn, and a state of the item to be worn.

4. The information processing apparatus according to claim 1, wherein
the at least one processor is configured to execute the instructions to determine the degree of risk of the object by using the object information and a positional relationship of the objects.

5. The information processing apparatus according to claim 1, wherein,
the at least one processor is configured to execute the instructions to determine the degree of risk of the object in a case where a predetermined precondition is detected, by using the object information.

6. The information processing apparatus according to claim 5, wherein
the at least one processor is configured to execute the instructions to:
detect the predetermined precondition by using at least one of sensor information and the object information; and
in a case where the predetermined precondition is detected, determine the degree of risk of the object by using the object information.

7. The information processing apparatus according to claim 1, wherein
the at least one processor is configured to execute the instructions to determine the degree of risk of the object by further using a history of the object information.

8. An information processing system comprising:
the information processing apparatus according to claim 1;
at least one capturing apparatus that generates a video by capturing the object region; and
an analysis apparatus that generates the analysis information by analyzing a video generated by the at least one capturing apparatus.

9. An information processing method including,
by one or more computers:
acquiring object information relating to an object captured in a video, by using analysis information acquired by analyzing the video capturing an object region; and
determining a degree of risk of the object by using the object information, wherein
the object information includes a position and a state of an accommodating tool.

10. A non-transitory computer readable medium recording a program for causing one or more computers to execute:
acquisition of object information relating to an object captured in a video, by using analysis information acquired by analyzing the video capturing an object region; and
determination of a degree of risk of the object by using the object information, wherein
the object information includes a position and a state of an accommodating tool.
